(19) United States
(12) Patent Application Publication
(10) Pub. No.: US 2010/0213688 A1
(43) Pub. Date: Aug. 26, 2010

(54) Trailer hitch for sprung suspension three wheel vehicle

(76) Inventor: James Henry Kuzara, Lakewood, CO (US)

Correspondence Address: James Kuzara, 4370 Kendrick Street, Golden, CO, 80403, US

(21) Appl. No.: 12/380,033

(22) Filed: Feb. 23, 2009

(51) Int. Cl. B60D 1/48; B23P 11/00

(52) U.S. Cl. 280/495; 29/428

(57) ABSTRACT

A trailer hitch for mounting on a vehicle having a single rear wheel which is suspended is mounted onto the frame of the vehicle above the single rear wheel. The hitch has wings which allow it to connect to projecting parts of the frame, frame rail seating and plates which may partially enclose the frame rail. A tubular receiver mount will accept a receiver having thereon a ball hitch or the like. The device may be dimensioned and configured for a particular model of vehicle frame rail, and may be mounted in the space between the frame rail and the rear wheel, thus avoiding any rearward stress on the flexible connections between a suspended rear wheel and the actual frame of the vehicle.

### FIELD OF THE INVENTION

This invention relates generally to tow hitch devices, and specifically to tow hitch devices for vehicles having a single rear wheel.

### STATEMENT REGARDING FEDERALLY FUNDED RESEARCH

This invention was not made under contract with an agency of the US Government, nor by any agency of the US Government.

### BACKGROUND OF THE INVENTION

The Can-Am (Bombardier) SPYDER brand vehicle (trademarks not associated with present applicant) is a unique vehicle offering riders a combination of motorcycle feel and ease of riding. The eye-catching aspect of the SPYDER is the fact that the tandem wheels are in front, unlike traditional three wheeled motorcycles and ATVs which have the pair of wheels in the back.

The SPYDER brand vehicle is a three wheeled vehicle which is straddled and ridden in a manner similar to a motorcycle. The rider wears a motorcycle helmet, feels the rush of the wind and buys the vehicle at a price normally associated with motorcycles. In the US, the SPYDER is legally treated as a motorcycle vehicle. Differences between the SPYDER and a normal motorcycle include the fact that it does not lean into turns and it has dynamic (three wheel) stability, rather than gyroscopic stabilization like a two wheel vehicle. The SPYDER is turned by use of a steering yoke, with one wheel advancing into a turn (the outer wheel) and one wheel retreating (the inner wheel). In general, the SPYDER's front end draws upon the snow-mobile expertise of the manufacturer.

The rear end of the SPYDER brand three wheel vehicle, however, is a single suspended drive wheel. This configuration means that the wheel is, like most automobile wheels, not directly connected to the frame of the vehicle. The frame of the vehicle does not extend back to the axle of the rear wheel.

FIG. 1 is a PRIOR ART side view of the rear end of a traditional bicycle or the like, showing a three sided frame extending to the axle of the rear wheel. This frame 102 has forks 104 which hold the axle 106 of wheel 108.

Clearly, it is very easy to attach a trailer to the frame 102 or the forks 104, as these are solid portions of the bicycle.

However, a SPYDER brand three wheel vehicle or vehicle with a single suspended rear wheel is somewhat different. FIG. 2 is a side view of such a vehicle, with a great number of components not shown for clarity.

Wheel 200 has a small wheel structure 212 which holds it but allows the wheel to flex up and down in response to bumps and irregularities in the roadbed, changes in vehicle load and so on. However, the connections of the wheel support 212 to the actual frame of the vehicle (not shown) is flexible. The first flexible support 218 to the vehicle 218 is composed primarily of two components, a shock absorber 214 and a suspension coil spring 216 which the shock fits inside of. This suspension system may be similar to those of four wheel vehicles or it may be different, and may use other components such as torsion members, leaf springs and so on. The second flexible support 220 to the vehicle frame may be as simple as a rotatable connector like a hinge or bearing or the like, about which the entire rear wheel assembly may pivot.

Needless to say, this design is excellent for performance and ride, but it is clearly not designed for safe towing. However, increasing numbers of riders desire to tour on their two wheel vehicles, yet are frustrated by limited storage space. An example of the limited storage space of the SPYDER brand vehicle is the fact that the front compartment located between the two front wheels is large enough to hold a helmet, or at most two helmets if chosen carefully.

Saddle bags may be improvised but they are insecure, limited and sometimes even dangerous under the wrong conditions.

Thus it would be preferable to provide a towing capability to two and three wheeled vehicles having suspended rear wheels, especially the popular SPYDER brand three wheel vehicle but also including many other vehicles as well.

It would further be preferable to provide a secure trailer towing hitch for vehicles having a suspended rear wheel and other vehicles in which the frame does not reach to the rear axle.

### SUMMARY OF THE INVENTION

### General Summary

The present invention teaches a trailer hitch for mounting on a vehicle having a single suspended rear wheel, that is, vehicles such as modern high performance motorcycles or the SPYDER brand three wheel vehicle.

The hitch of the invention is mounted onto the frame of the vehicle, under the seat or above the single rear wheel, where a projecting frame rail allows the mounting. In the preferred embodiment the hitch is mounted to the bottom of the frame rail but in alternative embodiments it might mount to the sides or top if it as well, depending on the layout of the vehicle frame rail.

The hitch has wings which allow it to connect to projecting parts of the frame such as turn signal supports or the like. A frame rail seat and plates are dimensioned and configured to snugly engage the frame rail of the vehicle and may partially enclose the frame rail.

A tubular receiver mount will accept a receiver having thereon a ball hitch or the like. The device mounts to the frame, avoiding the entire suspended rear-wheel and thus avoids placing any rearward stress on the flexible connections between a suspended rear wheel and the actual frame of the vehicle.

### SUMMARY IN REFERENCE TO CLAIMS

It is therefore another aspect, advantage, objective and embodiment of the invention, in addition to those discussed previously, to provide a tow hitch for use on a vehicle having a frame rail having sides and extending over a suspended rear wheel, the tow hitch comprising:
a first frame rail seating plate dimensioned and configured to engage to a first side of such frame rail, the first frame rail seating plate having a length and two opposing edges and upper and lower sides;
a second frame rail side plate dimensioned and configured to engage to a second side of such frame rail;
a third frame rail side plate dimensioned and configured to engage to a third side of such frame rail;
the second and third extending facing one another from the two opposing edges of the first frame rail seating plate upper side and parallel to the length of the first frame rail seating plate;
a receiver mounting tube extending coaxial to the length of the first frame rail seating plate lower side;
two wings extending from the two opposing edges of the first frame rail seating plate and the receiver mounting tube, the wings generally planar and perpendicular to the length of the first frame rail seating plate.

It is therefore another aspect, advantage, objective and embodiment of the invention, in addition to those discussed previously, to provide a tow hitch for use on a vehicle having a frame rail having sides and extending over a suspended rear wheel, the tow hitch further comprising:
a plurality of holes pre-drilled through at least one member selected from the group consisting of the wings, the first frame rail seating plate, the second and third frame rail side plates, and combinations thereof.

It is therefore another aspect, advantage, objective and embodiment of the invention, in addition to those discussed previously, to provide a tow hitch for use on a vehicle having a frame rail having sides and extending over a suspended rear wheel, the tow hitch further comprising:

an aperture passing through the receiver mounting tube.

It is therefore another aspect, advantage, objective and embodiment of the invention, in addition to those discussed previously, to provide a tow hitch for use on a vehicle having a frame rail having sides and extending over a suspended rear wheel, the tow hitch further comprising: a hitch/receiver pin dimensioned and configured to pass through the aperture passing through the receiver mounting tube.

It is therefore another aspect, advantage, objective and embodiment of the invention, in addition to those discussed previously, to provide a tow hitch for use on a vehicle having a frame rail having sides and extending over a suspended rear wheel, the tow hitch further comprising: a cotter key dimensioned and configured to pass about the hitch/receiver pin.

It is therefore another aspect, advantage, objective and embodiment of the invention, in addition to those discussed previously, to provide a tow hitch for use on a vehicle having a frame rail having sides and extending over a suspended rear wheel, wherein the receiver mounting tube has a square tubular cross section.

It is therefore another aspect, advantage, objective and embodiment of the invention to provide a method of mounting a trailer to a vehicle having a single suspended rear wheel but having a frame rail ending above the single suspended rear wheel, the method comprising the steps of:
a) providing a hitch dimensioned and configured to engage to such frame rail;
b) cutting away portions of the vehicle body surrounding the end of the frame rail so as to slightly expose the rear end of the frame rail;
c) mounting the hitch to such frame rail;
d) mounting a tow ball receiver to the hitch;
e) securing such trailer to such tow ball.

It is therefore another aspect, advantage, objective and embodiment of the invention to provide a method of mounting a trailer to a vehicle having a single suspended rear wheel but having a frame rail ending above the single suspended rear wheel wherein the mounting of the hitch to such frame rail further comprises one member selected from the group consisting of:

welding, bolting, riveting, adhering and combinations thereof.

It is therefore another aspect, advantage, objective and embodiment of the invention to provide a method of mounting a trailer to a vehicle having a single suspended rear wheel but having a frame rail ending above the single suspended rear wheel wherein the hitch further comprises:
a first frame rail seating plate dimensioned and configured to engage to such frame rail, the first frame rail seating plate having a length and two opposing edges and upper and lower sides;
a second frame rail side plate dimensioned and configured to engage to such frame rail;
a third frame rail side plate dimensioned and configured to engage to such frame rail;
the second and third extending facing one another from the two opposing edges of the first frame rail seating plate upper side and parallel to the length of the first frame rail seating plate;
a receiver mounting tube extending coaxial to the length of the first frame rail seating plate lower side;
two wings extending from the two opposing edges of the first frame rail seating plate and the receiver mounting tube, the wings generally planar and perpendicular to the length of the first frame rail seating plate.

### BRIEF DESCRIPTION OF THE DRAWINGS

FIG. 1 is a PRIOR ART side view of the rear end of a traditional bicycle or the like, with a triangular frame which secures the rear wheel in place and allows a hitch for a trailer to connect.

FIG. 2 is a side view of the rear end of a vehicle having a single rear wheel on a suspension, showing the lack of support structure for a trailer to connect to the frame.

FIG. 3 is a perspective view of the preferred embodiment of the invention, showing details of the hitch.

FIG. 4 is a bottom view of the invention.

FIG. 5 is a top view of the invention.

FIG. 6 is a side view of the invention (both sides are mirror images).

FIG. 7 is a frontal (perspective) view of the invention showing a view through the interior of the tubular receiver mount.

### INDEX TO REFERENCE NUMERALS

Frame 102
Forks 104
Axle 106
Wheel 108
Wheel 200
Wheel support 212
Shock 214
Suspension spring 216
First flexible support to vehicle 218
Second flexible support to vehicle 220
Receiver mount tube 402
Frame rail seating plate 404
Hitch end 406
Receiver mount aperture 408
Hitch/receiver pin 410
Cotter key 412
Wings 414a, 414b
Frame rail side plates 416, 418
Mounting notch 420
Pin hole 430
Frame holes 434
Receiver mount tube interior 450
Receiver mount tube distal aperture 452

### DETAILED DESCRIPTION

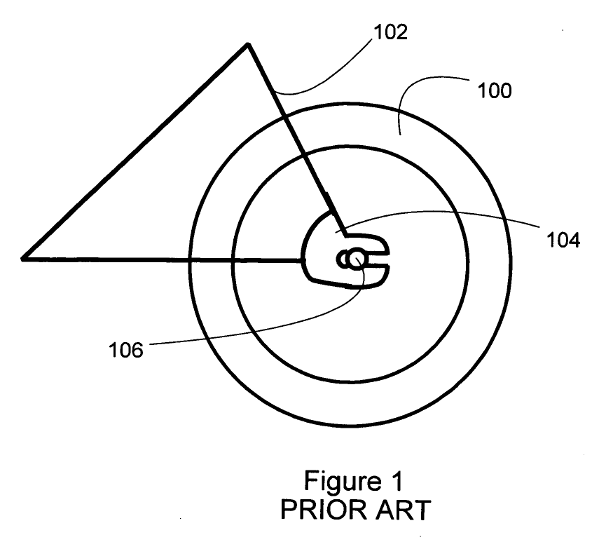

FIG. 1 is a PRIOR ART side view of the rear end of a traditional bicycle or the like, with a triangular frame which secures the rear wheel in place and allows a hitch for a trailer to connect. Wheel 100 is held between two usually identical halves of a frame 102, which has been simplified down to its basic triangle shape. Forks 104 hold the actual axle 106 in place and thus hold the wheel 100 in place. Drive may be supplied by chain, belt, shaft, etc.

If towing is desired on a vehicle like this, it is a relatively simple matter to connect a trailer tongue to the forks 104 or the frame 102. This known system can be used with almost any two wheeled vehicle, with the important limitation that the vehicle must be one with forks holding the axle. Thus many traditional or older motorcycles, bicycles and so on can do this, however, modern performance machines tend to have suspended rear wheels. The frame 102 does not extend to the axle 106, instead the two frame members which overlap the wheel may be reduced or eliminated entirely. This in turn means that the areas allowing attachment in traditional designs are not available in more modern motorcycle designs, nor in evolutionary three wheelers like the SPYDER brand three wheel vehicle.

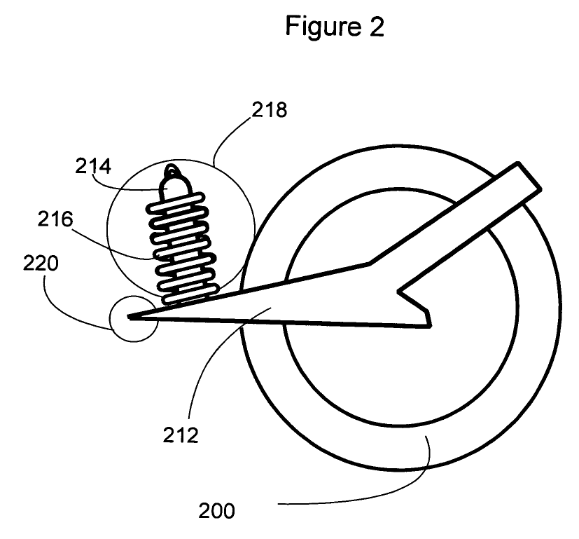

FIG. 2 is a side view of the rear end of a vehicle having a single rear wheel on a suspension, showing this lack of support structure for a trailer to connect to the frame. The two areas of attachment 220 and 218 are designed for cushioning the ride and providing steady traction and thus increased power. (Both areas 218 and 220 are depicted by circles in this diagram, the circles are not part of a real world machine.)

These areas support flexion of the rear wheel relative to the frame (not shown) of the cycle, but they are not designed for towing nor the loads associated therewith.

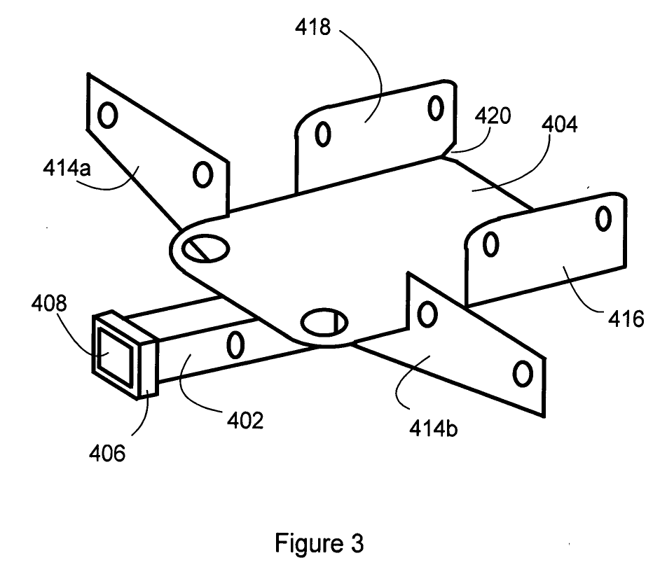

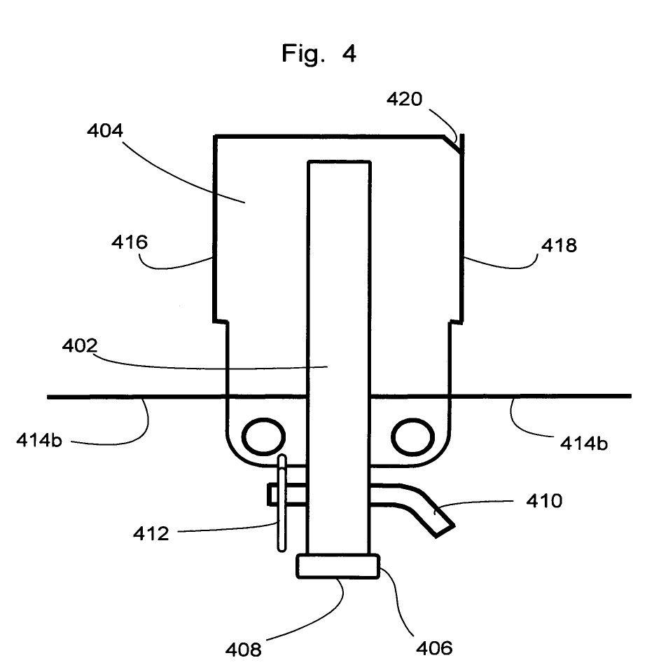

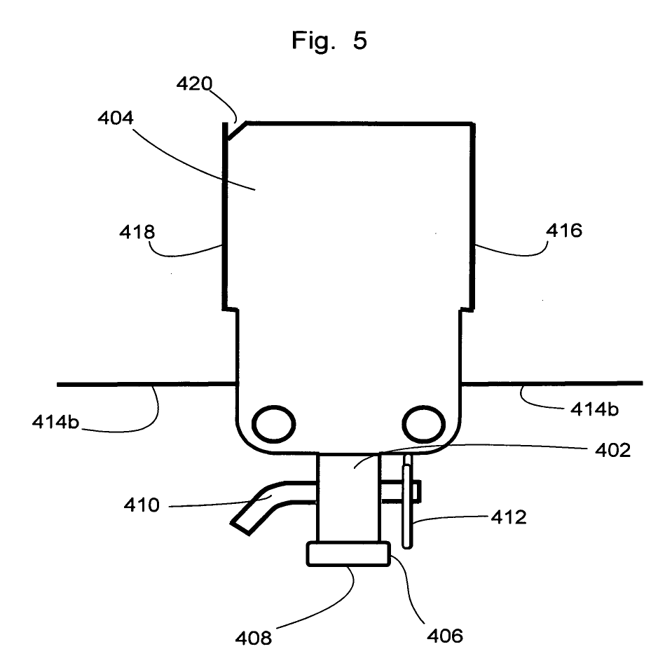

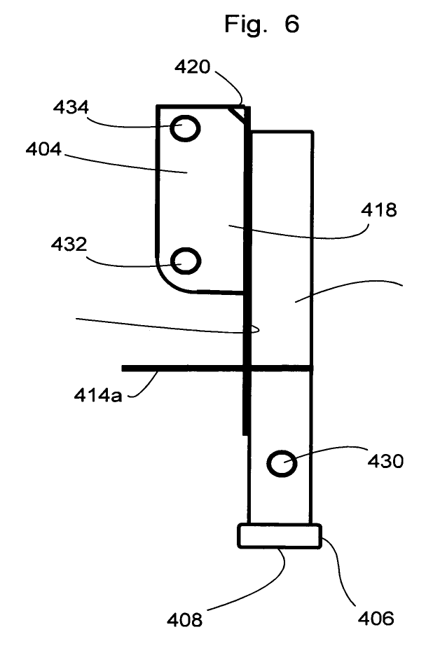

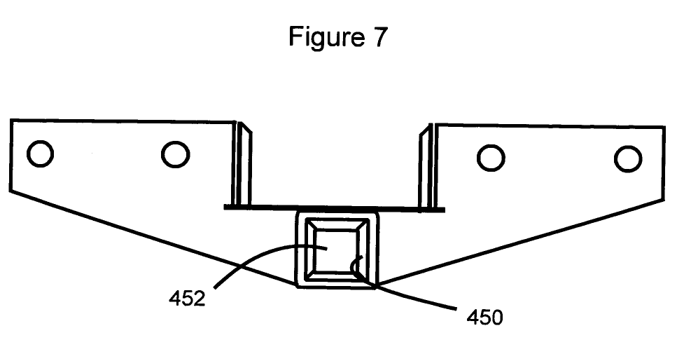

FIG. 3 is a perspective view of the preferred embodiment of the invention, showing details of the hitch, while FIG. 4 is a bottom view of the invention, FIG. 5 is a top view of the invention and FIG. 6 is a side view of the invention (note that both sides are the same). FIG. 7 is a frontal (perspective) view of the invention showing a view through the interior of the tubular receiver mount. Receiver mount tube 402 will attach to a receiver end with a tow ball at the other end: the receiver will fit into receiver mount aperture 408. While the mount tube 402 is depicted as a standard square shape, it will be understood that it can be circular in cross section and other shapes. When the receiver is mounted into the mount tube 402, then hitch/receiver pin 410 (FIGS. 4 and 5) will pass through both the mount tube 402 pin hole 430 and also through the receiver (which has a matching aperture) and be secured in place by cotter key 412. Cotter key 412 may be the type which actually passes through the pin 410 or it may merely encircle the pin tightly. By this means, the tow ball on the receiver may be firmly secured to the hitch itself despite the random pulls of towing.

Hitch end 406 will project into view above the rear wheel of the vehicle. If a retrofit is well done, this will be the only part visible when the hitch is mounted and covering the frame rail, and only a minimal amount of the frame rail will be visible when the hitch is not mounted.

Frame rail seating plate 404 forms the actual back bone of the hitch in the best mode and preferred embodiment: other structural parts are attached to or extend from the frame rail seating plate 404. When mounted to the frame rail, the frame rail seating plate 404 will span the bottom side of the frame rail from side to side and sit snugly against it. Frame rail side plates 416 and 418 then extend up the sides of the frame rail to partially enclose the frame rail. Attachments such as bolts passing through the various apertures then secure the devices together. Frame holes 434 for example allow long bolts to pass right through the rail side plates 416 and 418 and through matching holes in the frame rail itself. Note that most frame items on two wheel vehicles allow easy drilling of additional holes during retrofit, so holes may be located for maximum stress distribution benefits, rather than only at locations which already have holes in the frame. Wiring harnesses and the like will require care in making such drilling of new apertures, however.

Wings 414a and 414b serve a similar purpose. The wings are attached to both the frame rail seating plate 404 and also the mounting tube 402 for extra support. The perpendicular wings, which extend at 90 degrees to the length of the frame rail seat plate, allow even firmer attachment to any projections from the frame rail of the vehicle, or even to structures near the frame rail but not attached to it. For example, in the SPYDER brand three wheel vehicle, turn signal supports of some sturdiness extend perpendicular to the frame rail and the perpendicular planar winds seat snugly against them, allowing the wings to be bolted to the turn signal supports. Such wings may be dimensioned and configured the shape of the vehicle frame rail.

Mounting notch 420 on the other hand allows clearance of obstacles which may intrude and may also provide a physical guide to proper mounting of the device on the vehicle.

FIG. 7 shows a perspective and straight frontal view demonstrating that the mounting tube 402 is hollow, with a receiver mount tube interior 450 which seats up against the receiver of the tow ball when the receiver is inserted.

Receiver mount tube distal aperture 452 may be seen, as the front end of the mount tube may be opened or closed.

In alternative embodiments, the hitch may mount to the sides or top of the frame rail, rather than to the bottom, the wings may be shaped differently so as to accommodate different frame designs or structures, the size and shape of the plates and holes may be varied to suit the particular vehicle of choice and so on. For example, in a vehicle with a circular frame rail, the frame rail side plates and frame rail seating plate may form a semi-circular trough in a single radius to grip the circular frame rail.

In the presently preferred embodiment and best mode presently contemplated for carrying out the invention, a method embodiment may be used with a hitch, even if the hitch of different shape. The steps of the invention are found in TABLE ONE.

### Table One

a) Provide a hitch dimensioned and configured to engage to such frame rail, such as the hitch of the present invention.
b) Cutting away portions of the vehicle body surrounding the end of the frame rail so as to slightly expose the rear end of the frame rail, this step may further involve partially disassembling the vehicle to cut away only the body or fender or seat areas necessary to expose the minimum area of the frame rail, in fact, ideally, the frame rail itself is not exposed, only the projecting end of the hitch 406. The embodiment of the present invention shown in FIGS. 4 through 7 has a fairly small tubular receiver mount.
c) Mounting the hitch to such frame rail, preferably by means of bolts, which are easy to retrofit, however, welding, riveting, gluing and so on as necessary may be used.
d) Mounting a tow ball receiver to the hitch: the tow ball receiver will have a square end suitable for a square tube such as 402, and a ball end.
e) Securing such trailer to such tow ball in a fairly traditional manner, though the ball selected may be a fairly small size.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A tow hitch for use on a vehicle having a frame rail having sides and extending over a suspended rear wheel, the tow hitch comprising:
a first frame rail seating plate dimensioned and configured to engage to a first side of such frame rail, the first frame rail seating plate having a length and two opposing edges and upper and lower sides;
a second frame rail side plate dimensioned and configured to engage to a second side of such frame rail;
a third frame rail side plate dimensioned and configured to engage to a third side of such frame rail;
the second and third extending facing one another from the two opposing edges of the first frame rail seating plate upper side and parallel to the length of the first frame rail seating plate;
a receiver mounting tube extending coaxial to the length of the first frame rail seating plate lower side;
two wings extending from the two opposing edges of the first frame rail seating plate and the receiver mounting tube, the wings generally planar and perpendicular to the length of the first frame rail seating plate.

2. The tow hitch of claim 1, further comprising:
a plurality of holes pre-drilled through at least one member selected from the group consisting of the wings, the first frame rail seating plate, the second and third frame rail side plates, and combinations thereof.

3. The tow hitch of claim 1, further comprising:
an aperture passing through the receiver mounting tube.

4. The tow hitch of claim 3, further comprising:
a hitch/receiver pin dimensioned and configured to pass through the aperture passing through the receiver mounting tube.

5. The tow hitch of claim 4, further comprising:
a cotter key dimensioned and configured to pass about the hitch/receiver pin.

6. The tow hitch of claim 1, wherein the receiver mounting tube has a square tubular cross section.

7. A method of mounting a trailer to a vehicle having a single suspended rear wheel but having a frame rail ending above the single suspended rear wheel, the method comprising the steps of:
a) providing a hitch dimensioned and configured to engage to such frame rail;
b) cutting away portions of the vehicle body surrounding the end of the frame rail so as to slightly expose the rear end of the frame rail;
c) mounting the hitch to such frame rail;
d) mounting a tow ball receiver to the hitch;
e) securing such trailer to such tow ball.

8. The method of mounting a trailer to a vehicle of claim 7, wherein the mounting of the hitch to such frame rail further comprises one member selected from the group consisting of:
welding, bolting, riveting, adhering and combinations thereof.

9. The method of mounting a trailer to a vehicle of claim 7, wherein the hitch further comprises:
a first frame rail seating plate dimensioned and configured to engage to such frame rail, the first frame rail seating plate having a length and two opposing edges and upper and lower sides;
a second frame rail side plate dimensioned and configured to engage to such frame rail;
a third frame rail side plate dimensioned and configured to engage to such frame rail;
the second and third extending facing one another from the two opposing edges of the first frame rail seating plate upper side and parallel to the length of the first frame rail seating plate;
a receiver mounting tube extending coaxial to the length of the first frame rail seating plate lower side;
two wings extending from the two opposing edges of the first frame rail seating plate and the receiver mounting tube, the wings generally planar and perpendicular to the length of the first frame rail seating plate.
